(19) United States
(12) Patent Application Publication
(10) Pub. No.: US 2014/0344091 A1
(43) Pub. Date: Nov. 20, 2014

(54) System for 3D Printing of Personalized Informational Objects

(71) Applicant: ACCULATION, INC., Los Angeles, CA (US)

(72) Inventor: Werner Guether Krebs, Los Angeles, CA (US)

(73) Assignee: ACCULATION, INC., Los Angeles, CA (US)

(21) Appl. No.: 14/280,684

(22) Filed: May 19, 2014

Related U.S. Application Data
(60) Provisional application No. 61/825,103, filed on May 20, 2013.

(51) Int. Cl. B29C 67/00; G06Q 30/06

(52) U.S. Cl. CPC B29C 67/0088; G06Q 30/0601; B29L 2031/7232
USPC 705/26.1

(57) ABSTRACT

The invention describes a web-based business and associated computer software that permits the generation and additive manufacture (e.g., 3D printing) of personalized and heavily customized objects (such as a medical information or advertising bracelet) that combine a personalized informational aspect (such as medical information, medical symbols, a corporate logo, or advertising), an optional electronic component (such as a transponder, computer interface or smartwatch) together with either standardized bracelet templates or user-submitted high fashion designs that are the optionally resized to dimensions selected by the user.

### RELATED APPLICATIONS

The present application is a continuation-in-part application of U.S. provisional patent application, Ser. No. 61,825,103, filed May 20, 2013, for 3D PRINTING OF PERSONALIZED INFORMATIONAL OBJECTS, by Werner Guether Krebs, included by reference herein and for which benefit of the priority date is hereby claimed.

### FIELD OF THE INVENTION

The present invention relates to a system for computer-controlled additive manufacturing of personalized informational objects and, more particularly, to an online marketplace (e.g. website or mobile app) and associated computer software and hardware that permits the generation and manufacture of personalized informational objects (e.g., wearable electronic devices) via an additive manufacturing system (e.g., 3D printer)

### BACKGROUND OF THE INVENTION

The inventor was considering improvements to electronic medical information bracelets, smartwatches, and wearable computers, which consist of a jewelry-like component together with electronic components. The inventor was interested in new technologies for rapidly manufacturing highly individualized medical information or advertising bracelets that were appropriately sized for a given patient, could display personalized medical or other information using raised writing or engraving, include electronic components such as those RFID chips or USB interfaces. The inventor had a background in both engineering and marketing and was aware that individualized wearable computers would find command significantly higher utility in the marketplace, in addition to potentially being lifesaving if such designs conveyed critical information to first responders. It would therefore also be desirable to incorporate high-fashion, unique designs and marketing from established bracelet fashion designers submitted in 3D file format for additive manufacturing. The author was also familiar with the use of bracelets in advertising, such as the well-known “LiveStrong” charity or advertising bracelets.

Wearable computing and bracelets with medical information or advertising slogans have been known for many years, but have been chiefly created using traditional manufacturing processes, which limit customization. Websites that permit generation of a single piece of custom jewelry using mathematical algorithms are known, such as n-e-r-v-o-u-s.com, but do not permit the combination of a unique mathematical design with an advertising slogan or a standardized receptacle for an electronic component such as USB memory stick or smartwatch display. 3D printing marketplaces such as Shapeways are known, but only sumbmission of a single manufacturing file. Since the original filing date of this patent, Ebay and Makerbot launched its Ebay Exact app, which includes some features anticipated by this original patent application, although lacks many of the promising features anticipated in this patent.

Additive manufacturing such as 3D printing appeared to be an ideal method to generate such advertising bracelets in small quantities, but there appeared to be no software, websites or commercial marketplaces to support the inventor's application. Surprisingly, there is no marketplace for individual components that can be combined by 3D printing marketplace vendors (e.g., Shapeways, e.g., combining high-fashion jewelry design with a medical bracelet component, or a high-fashion jewelry design with the latest smartwatch component). If the user wishes to create a chimera, this must be done manually, a process that can take hours is prone to error, requiring the user to reprocess the file using available home software which may then be rejected with unmanufacturable for cryptic after 20 minutes or so by Shapeways or other 3D marketplace system. A marketplace is needed whereby individual jewelry components are pre-vetted by the 3D marketplace as manufacturable, and the marketplace itself must take responsibility that chimera purchased by the user from component templates on the site are ultimately manufacturable. Surprisingly, despite being back by a leading on-line retailer and a world expert in 3D printing, at time of writing the app does not implement many of the features anticipated by the author's original application, such as a library of component designs to be combined in a chimera, or the use of splice points in components to enable algorithmic combining. It does not allow printing of medical information bracelets or smartwatches, although it does allow printing of a traditional mechanical watch and watchband. Although this patent application originally anticipated that such apps would allow such watchbands to be customized in unique sizes with text, printed medical information and/or symbols for first responders, and electronic components, the Ebay Exact app at time of writing allows the printing of only a single, standardized watch, which can be “customized” and “resized” by the user not in software as anticipated by this patent application at original filing, but by the snapping in and out of components by the purchaser at receipt. In the Ebay Exact app at time of writing (the Ebay Exact app did not exist at original filing) there is no way to combine the receptacle for the traditional mechanical watch with a high-fashion design or jewelry in the shape of a family heirloom as original anticipated by this application would be advantageous to provide an on-line marketplace for 3D printing items that would permit the user to automatically combine different designs (for example a family heirloom unique high-fashion bracelet together with a standard attachment for a smartwatch) in a way that would eliminate many hours of high-risk manual file manipulation but instead would largely guarantee such automatic chimera designs could be successfully manufactured

It would also be advantageous to provide a mechanism for further personalization of such items, such as allowing high-fashion bracelets or wearable electronics to be further personalized with medical information symbols or text, or advertising symbols or text, or a unique design that would uniquely identify the individual or the individual's project values

It would further be advantageous to provide a mechanism for automatically combining in electronic format these personalized items with standardized items, such as a standardized connector to a smartwatch, for subsequent, efficient manufacturing of the personalized product as a single object through electronic manipulation of the design data within the manufacturing system or hardware

Being able to add personalized medical information (e.g., allergies) or traditional printed information or symbols to communicate to first responders while a patient is unconscious that the same wearable electronic device bearing those symbols provides a patient's complete medical history clearly has lifesaving potential and therefore is obviously advantageous. Moreover, being able to add medical information to a high-fashion jewelry or smartwatch when the product is ordered through an efficient, additive manufacturing process is also clearly advantageous because it eliminates the need for a second bulky and often unattractive medical bracelet by consolidating that functionality into a bracelet, watch, or smartwatch.

For unknown reasons, certain allergies are on the rise in children and young adults, a demographic that is likely to partially coincide with smartwatch early adopters. Secondly, patients in need of communicating detailed personal histories to first responders in an emergency are more likely to require a wearable electronic device (such as a smartwatch, USB memory stick, or RFID chip) that can efficiently communicate these detailed personal histories to first responders. However, these devices will require traditional markings, such as a traditional raised symbol or raised text designating a specific, broad category of allergy or medical condition, as known to those skilled in the art. Therefore, it is advantageous to combine wearable medical devices with techniques for customizing wearable electronics or jewelry with efficient manufacturing processes for placing personalized raised text on these devices.

Creating a design for jewelry or an attachment point for a wearable electronic device as a design for an additive manufacturing process is highly non-trivial. Often a great deal of effort is required to create a design that meets technical requirements, is aesthetically pleasing, and meets marketplace expectations. Significant computer time simplifying the data description of an object (e.g., by reducing the number of polygons) may need to be expended, as is known to those skilled in the art. 3D designs that appear to be manufacturable according to commonly recommended end-user software may fail for cryptic reasons when submitted to a 3D printing marketplace such as Shapeways. 3D marketplace personal are typically reliant on the same commonly recommended end-user software (as opposed to the customer software being used to drive the manufacturing printer) and so find such errors extremely difficult to diagnose. Different materials may need to be experimented with. Repeated trial and error may be required before a design meets both technical requirements and finds marketplace success. Having an end-user then tweak the 3D designs is generally not currently practical, as tweaking the design data files would like break the manufacturing process as currently practiced. It would therefore be advantageous to have an on-line marketplace, such as a website or mobile app, that would economically segregate the work of the fashion designer, or the person creating the design for a standardized electronic attachment, with separate designs (or template libraries) for the aspects of the product that need to be personalized (e.g., the sections that will bear medical information symbols). By separating these two components out into separate marketplaces (or, as separate template libraries as described herein) different individuals would be able to work on the different components, and the separate components could be tested independently in the marketplace, greatly speeding development. As currently practiced, there is no way to purchase a combination or chimera of different 3D designs to be manufactured into a single product. Rather, each design is assumed to compromise a complete product on prior art on-line marketplaces, and cannot be combined with another design on the marketplace to produce a chimera or combined product.

The importance of personalization of wearable electronics is currently under appreciated. This is because most engineers do not have significant familiarity with marketing, evolutionary biology, or first responder needs, and focus exclusively on the utilitarian or functional aspects of the electronics. The advantages of factoring in the needs of first responders has already been discussed. Persons with a marketing background further appreciate that adding high-fashion significantly increases the market value of wearable electronics, but the existing literature still does not fully appreciate the reasons for this due to lack of familiarity with evolutionary biology. There is archaeological and anthropological evidence suggesting that humans of both genders have needed to communicate tribal and individual identity overlong distances to friendly and hostile neighboring tribes, and did so using highly personalized designs on weapons and jewelry more than 50,000 years before the invention of written language. Failure to properly communicate ones tribe or individual identity in this way could be life-threatening, suggesting an strong evolutionary biological utility behind jewelry and device personalization. This is not yet appreciated in the literature. For example, there have been numerous widely-read newspaper accounts of Google Glass wearers being subjected to violence because the device is associated with gentrification. In at least one incident, the San Fransisco crime victim was a humble press reporter who claimed to sympathize with those attacking him and was supposedly merely testing the device, but was mistaken by the community for a member of the gentry using the device to put on airs. In this way, Google Glass provides a visual clue to tribal identity in a manner similar to a coat of arms or a flag. It might also provide facilitate long-distance identification of individual identity, similar to the function of the famous hat of Abraham Lincoln or the custom turtleneck worn by Steve Jobs. It might simply allow pairs of Google Glass to be distinguished between family members. But recent widely-read newspaper articles describe Google Glass as either ‘stylish’ or ‘dorky.’ In the latter description it was suggested that, had Google Glass copied a pair of glasses designed by a famous fashion house, it would suddenly become ‘stylish.’ These discussions ignore the evolutionary biology behind ‘style’, which is distance identification of tribal and individual identity. If Google Glass simply mass produced the fashion house style, that style would then become associated with the Google Glass, and might equally then become unstylish and potentially subject the wearer to violence. A smartwatch might also become associated with gentry and subject the wearer to violence in hostile territory (such as, apparently, San Fransisco). It would be advantageous, when traveling through such hostile territory, if the smartwatch could be personalized with the symbols of a friendly tribe (such as a local hero), a neutral symbol (e.g., the traditional ‘press’ on a white background, to signify a non-combatant), or to use personalization manufacturing technology camouflage the device as appearing to be non-gentrified low-tech device. There is a very strong biological basis to personalize wearable items, including wearable electronics, but this continues to be under-appreciated by the industry. The surprise of the press in reporting violence against Google Glass users testifies to a continued lack of appreciated for the biological need to personalize these items. It would therefore be highly advantageous, and potentially lifesaving, to facilitate easy personalization of wearable electronics with custom 3D shapes at purchase.

### SUMMARY OF THE INVENTION

In accordance with the present invention, there is provided an online marketplace (e.g. website or mobile app) and associated computer software and hardware that permits the generation and manufacture of personalized informational objects (e.g., wearable electronic devices) via an additive manufacturing system (e.g., 3D printer), which are either directly interconnected, or, in one embodiment, indirectly interconnected via an intervening electronic system for combining electronic designs for manufactured components. A typical embodiment of the invention is anticipated to include a personalized or fashion template library and standardized component template library embedded within the online marketplace (e.g. website or mobile app) and associated computer software and hardware.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a plan view of a system for 3d printing of personalized informational objects.

For purposes of clarity and brevity, like elements and components will bear the same designations and numbering throughout the Figures.

### DESCRIPTION OF THE PREFERRED EMBODIMENT

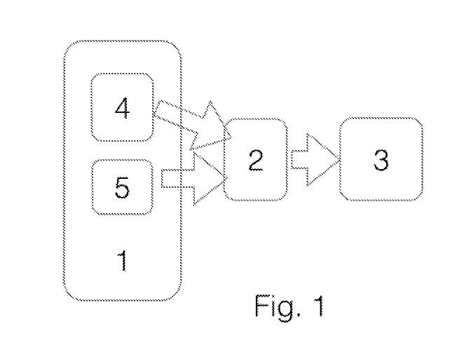

FIG. 1 which is a plan view of the System for 3D printing of personalized informational objects describes an online marketplace (e.g. website or mobile app) and associated computer software and hardware 1 that permits the generation and manufacture of personalized informational objects (e.g., wearable electronic devices) via an additive manufacturing system (e.g., 3D printer) 3, which are either directly interconnected, or, in one embodiment, indirectly interconnected via an intervening electronic system for combining electronic designs for manufactured components 2. A typical embodiment of the invention is anticipated to include a personalized or fashion template library 4 and standardized component template library 5 embedded within the online marketplace (e.g. website or mobile app) and associated computer software and hardware 1.

The preferred embodiment of the invention involves a system that permits the manufacture of a heavily personalized bracelet that combines a personalized informational aspect (such as emergency medical information, medical symbols, corporate logos, or advertising), means for attaching or incorporating optional electronic component (such as a computer interface or medical information transponder) together with either standardized bracelet templates or high fashion designs (user submitted, previously deposited in a template library, or algorithmically generated) that are then optionally resized to the user's dimensions (wrist size in the preferred embodiment).

The need for extreme personalization of medical information bracelets, individualized high fashion bracelets, or small run advertising bracelets motivated the inventor to combine a web-based business with 3D printing technology.

The user, patient, health care provider or other authorized user would visit the web-site, specify the personalized characteristics of his or her bracelet, optional indicate payment and shipment address, and receive either a 3D printable computer file or a shipped physical bracelet. Personalized attributes specifiable by the user might include object size, color, personal medical information/corporate logo/advertising slogan, desired electronic component, underlying high fashion design template, etc. Computer software related to the website business would then generate a computer model of the bracelet or other object suitable for 3D printing, such as an STL file. The software would resize bracelet designs (such as from a high-fashion 3D bracelet template library, or from an STL or similar 3D design of a high-fashion bracelet generated by other means or imported by the user to the website but meeting certain specifications, such as splice points along the circular edge of the bracelet). The website would have a library of generic designs, such as a 3D model for a plain vanilla ring-shaped bracelet in various widths, wrist sizes or radius, and thicknesses suitable to different materials. Also, it is becoming increasingly common for fashion designers to prototype high-fashion jewelry such as bracelets as computer files for 3D printing. While this is sometimes used in support of more traditional manufacturing processes, some fashion designers sell or otherwise make their designs available as 3D printable computer files, and the web-site end user might be able to upload a high-fashion bracelet design 3D computer model to the website for further automatic or semi-automatic modification to incorporate medical information, electronic components, or advertisements. Alternatively, a fashion designer might also make arrangements with the website to have their designs added to the template library available on the website for selection or purchase by the user; such an arrangement would ensure compatibility between the bracelet and the herein described customization software means. Finally, a template for a high-fashion bracelet might be designed by random process or computer algorithm, such as is currently done by the website n-e-r-v-o-u-s.com; a user might upload a file bracelet designed by such a computer algorithm, or the website might make arrangements with the purveyor of the high-fashion bracelet designing algorithm. These bracelet templates would then be further customized by adding text, logos, mechanical latches for concealing medical information or similar component for preserving patient privacy, and compartments or similar for holding electronic components and/or printed labels. If necessary, the software would resize the initial, putative bracelet template to the user's wrist. If a compartment for electronic components were selected by the user (such as a compartment for an RFID or USB interface), the software would select an appropriately-sized compartment from a 3D template library and splice the design for this compartment into the overall 3D model for the bracelet, for example by using predetermined splice points along the circular edge of the bracelet. Similar, other components, such as a mechanical latch or clasp for concealing medical information hidden underneath the latch, in order to preserve patient privacy yet allow medical personal access to the information in an emergency, might be selected. Similar customized mechanical clasp component might be selected by the user, allowing the user choice as to his or her preferred clasp style (for example, a box clasp, a hook, a lobster claw, spring, toggle, or extender clasp style.) Finally, optionally, computer software would generate a component containing raised or sunken text or symbols. In one embodiment, a flat 3D computer model of the 3D engraved, sunken, or raised text, medical symbols, or corporate or other logos would be generated in the dimensions of the bracelet's width and thickness. This flat piece would then be transformed into a 3D curved piece matching the bracelet's curvature using 3D shape bending transformation algorithms widely known to those skilled in the 3D modeling technologies. This piece of the bracelet would then be spliced together with the rest of the 3D bracelet model using splicing techniques similar to those already described. Information about the material selected by the user (e.g., different colored plastics) would be added to the metadata describing the 3D model of the bracelet. The resulting 3D model would then be rotated as appropriate for manufacture in the given material. To ensure successful manufacture, the resulting model would then optionally be run through standard 3D model validation and correction software known to those skilled in the art.

The resulting 3D bracelet model might then be presented to the user for download in a standard 3D printing file format such as STL (upon optional payment through a suitable method such as credit card) for the user to manufacture elsewhere. (For example, the user might use one of several commercial websites that print 3D files for manufacture. Alternatively, the user might print the file on their own home 3D printer.) In an alternative embodiment of the invention, the website might itself print and ship the custom bracelet to the user, and optional charge the user appropriately. Finally, if a large run of the bracelet is desired, rather than printing on a 3D printing, the website might offer options to allow the resulting 3D computer model files to be used in a more traditional manufacturing process that is more economical for larger batch sizes.

Surprisingly, an out-of-band mechanism 10 for communicating chimera construction from components to all stages in additive manufacturing system workflow may be beneficial in reducing the likelihood of work stoppages due to process exception conditions, and is anticipated as one potential embodiment of this invention. The data file most commonly used for communicating 3D designs is still the STL file, which is several decades old. It lacks the ability to communicate designs comprising of multiple colors or materials, so for some designs more modern formats, such as those based on 3D graphics systems, must be used. But at time of writing, however, most software still assumes STL files, and processing of designs require non-STL data formats may be impeded by the inferior software available for these methods. If STL files are used to describe multiple components, although the individual STL files may be manufacturable, the combined STL may not be for highly technical and at times cryptical reasons. For example, the combined STL file may contain too many polygons for the amount of memory available in the 3D printer. This is easy rectified using standard processing software, which can reduce the number of polygons in the combined object, often without otherwise changing the result product. However, such combined file may still fail to manufacturer for hard to diagnose reasons, as the software triggering the error condition may reside in the 3D printer and may unfortunately be somewhat different from the software commonly used to attempt to diagnose the problem. This difficulty is one of the motivations for this invention, as it would advantageous, rather than forcing end-users to create these chimeras with extremely difficult, but instead to create separate marketplaces for the components, and make the creation of the chimera product the responsibility of the web marketplace rather than the end user. This would also allow independent evolution of different modules in the marketplace. Technically, this problem can be solved a number of ways. In addition to creating the product as a single STL file, a separate bundle consisting of the original STL files, together with metadata on how to combine them, can also be passed to the software. In this way, if manufacture of the single STL file fails at point in the workflow (e.g., due to very conservative checks in the manufacturing software at one stage), the individual STL files provided via the out-of-band mechanism 10 can still be inspected and passed by the same software (having already previously passed such inspection in order to enter the template library in the first place), allowing work to continue to move forward through the manufacturing workflow Without more widespread adoption of the more capable non-STL formats, it would be advantageous to include machine-readable descriptions in these files of how the combined object is created from the components (either by separately describing the polygons for meshes and the individual components in much the same way as the bundle of STL files just described, or by allowing manufacturing software to generate the final component from the component descriptions). These file formats have mechanisms for describing multi-component objects in computer graphics, although these multi-component features are typically not used or implemented in 3D printing. For example, changes could be made to the prior art to enable a subset of these 3D computer graphics features in the commonly used non-STL formats to also be supported in 3D manufacturing. These out-of-band mechanisms would ensure that further downstream stages in the manufacturing process would be more likely to succeed in confirming that the chimera product is manufacturable.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A system for 3d printing of personalized informational objects for manufacture of highly-personalized electronic devices such as medical information bracelets with an electronic component or wearable electronic devices embedded in highly personalized jewelry designs, comprising:
means for permitting the buying, selling, commissioning, and/or pre-vetting of electronic-format component designs whose design data are to be combined automatically and/or personalized automatically to custom buyer specification and then manufactured in a computer-controlled or additive manufacturing process; and
means for computer-controlled manufacturing process (e.g., a 3d printer) and associated computer-based design data.

2. The system for 3d printing of personalized informational objects in accordance with claim 1, wherein said means for permitting the buying, selling, commissioning, and/or pre-vetting of electronic-format component designs whose design data are to be combined automatically and/or personalized automatically to custom buyer specification and then manufactured in a computer-controlled or additive manufacturing process comprises an online marketplace (e.g. website or mobile app) and associated computer software and hardware.

3. The system for 3d printing of personalized informational objects in accordance with claim 1, wherein said means for computer-controlled manufacturing process (e.g., a 3d printer) and associated computer-based design data comprises an additive manufacturing system (e.g., 3d printer).

4. A system for 3d printing of personalized informational objects for manufacture of highly-personalized electronic devices such as medical information bracelets with an electronic component or wearable electronic devices embedded in highly personalized jewelry designs, comprising:
an online marketplace (e.g. website or mobile app) and associated computer software and hardware, for permitting the buying, selling, commissioning, and/or pre-vetting of electronic-format component designs whose design data are to be combined automatically and/or personalized automatically to custom buyer specification and then manufactured in a computer-controlled or additive manufacturing process; and
an additive manufacturing system (e.g., 3d printer), for computer-controlled manufacturing process (e.g., a 3d printer) and associated computer-based design data.

5. The system for 3d printing of personalized informational objects as recited in claim 4, further comprising:
an electronic system for combining electronic designs for manufactured components, for efficiently and automatically creating a chimera product or component to be additively manufactured by automatically combining and reprocessing electronic-format design data from previously separate, optionally pre-vetted electronic-format component designs in response to custom user specification, effectively interconnected to said online marketplace (e.g. website or mobile app) and associated computer software and hardware, and effectively interconnected to said additive manufacturing system (e.g., 3D printer).

6. The system for 3d printing of personalized informational objects as recited in claim 4, further comprising:
a personalized or fashion template library, for describing in electronic format highly-personalized items (e.g., high-fashion jewelry or customized medical information bracelets or advertising bracelets) to be electronically combined with other component designs in an additive manufacturing process, effectively embedded to said online marketplace (e.g. website or mobile app) and associated computer software and hardware.

7. The system for 3d printing of personalized informational objects as recited in claim 4, further comprising:
a standardized component template library, for describing in electronic format standardized components (e.g., receptacle for smartwatch, traditional watch, usb memory stick, RFID chip) to be electronically combined with other component designs in an additive manufacturing process, effectively embedded to said online marketplace (e.g. website or mobile app) and associated computer software and hardware.

8. The system for 3d printing of personalized informational objects as recited in claim 4, further comprising:
an out-of-band mechanism, for describing in a machine-readable way the construction of the chimera from its component data to all stages in the manufacturing workflow.

9. The system for 3d printing of personalized informational objects as recited in claim 5, further comprising:
a personalized or fashion template library, for describing in electronic format highly-personalized items (e.g., high-fashion jewelry or customized medical information bracelets or advertising bracelets) to be electronically combined with other component designs in an additive manufacturing process, effectively embedded to said online marketplace (e.g. website or mobile app) and associated computer software and hardware.

10. The system for 3d printing of personalized informational objects as recited in claim 5, further comprising:
a standardized component template library, for describing in electronic format standardized components (e.g., receptacle for smartwatch, traditional watch, usb memory stick, RFID chip) to be electronically combined with other component designs in an additive manufacturing process, effectively embedded to said online marketplace (e.g. website or mobile app) and associated computer software and hardware.

11. The system for 3d printing of personalized informational objects as recited in claim 5, further comprising:
an out-of-band mechanism, for describing in a machine-readable way the construction of the chimera from its component data to all stages in the manufacturing workflow.

12. The system for 3d printing of personalized informational objects as recited in claim 6, further comprising:
a standardized component template library, for describing in electronic format standardized components (e.g., receptacle for smartwatch, traditional watch, usb memory stick, RFID chip) to be electronically combined with other component designs in an additive manufacturing process, effectively embedded to said online marketplace (e.g. website or mobile app) and associated computer software and hardware.

13. The system for 3d printing of personalized informational objects as recited in claim 6, further comprising:
an out-of-band mechanism, for describing in a machine-readable way the construction of the chimera from its component data to all stages in the manufacturing workflow.

14. The system for 3d printing of personalized informational objects as recited in claim 7, further comprising:
an out-of-band mechanism, for describing in a machine-readable way the construction of the chimera from its component data to all stages in the manufacturing workflow.

15. The system for 3d printing of personalized informational objects as recited in claim 9, further comprising:
a standardized component template library, for describing in electronic format standarized components (e.g., receptacle for smartwatch, traditional watch, usb memory stick, RFID chip) to be electronically combined with other component designs in an additive manufacturing process, effectively embedded to said online marketplace (e.g. website or mobile app) and associated computer software and hardware.

16. The system for 3d printing of personalized informational objects as recited in claim 9, further comprising:
an out-of-band mechanism, for describing in a machine-readable way the construction of the chimera from its component data to all stages in the manufacturing workflow.

17. The system for 3d printing of personalized informational objects as recited in claim 10, further comprising:
an out-of-band mechanism, for describing in a machine-readable way the construction of the chimera from its component data to all stages in the manufacturing workflow.

18. The system for 3d printing of personalized informational objects as recited in claim 12, further comprising:
an out-of-band mechanism, for describing in a machine-readable way the construction of the chimera from its component data to all stages in the manufacturing workflow.

19. The system for 3d printing of personalized informational objects as recited in claim 15, further comprising:
an out-of-band mechanism, for describing in a machine-readable way the construction of the chimera from its component data to all stages in the manufacturing workflow.

20. A system for 3d printing of personalized informational objects for manufacture of highly-personalized electronic devices such as medical information bracelets with an electronic component or wearable electronic devices embedded in highly personalized jewelry designs, comprising:
an online marketplace (e.g. website or mobile app) and associated computer software and hardware, for permitting the buying, selling, commissioning, and/or pre-vetting of electronic-format component designs whose design data are to be combined automatically and/or personalized automatically to custom buyer specification and then manufactured in a computer-controlled or additive manufacturing process;
an electronic system for combining electronic designs for manufactured components, for efficiently and automatically creating a chimera product or component to be additively manufactured by automatically combining and reprocessing electronic-format design data from previously separate, optionally pre-vetted electronic-format component designs in response to custom user specification, effectively interconnected to said online marketplace (e.g. website or mobile app) and associated computer software and hardware;
an additive manufacturing system (e.g., 3d printer), for computer-controlled manufacturing process (e.g., a 3d printer) and associated computer-based design data, effectively interconnected to said electronic system for combining electronic designs for manufactured components;
a personalized or fashion template library, for describing in electronic format highly-personalized items (e.g., high-fashion jewelry or customized medical information bracelets or advertising bracelets) to be electronically combined with other component designs in an additive manufacturing process, effectively embedded to said online marketplace (e.g. website or mobile app) and associated computer software and hardware;
a standardized component template library, for describing in electronic format standardized components (e.g., receptacle for smartwatch, traditional watch, usb memory stick, RFID chip) to be electronically combined with other component designs in an additive manufacturing process, effectively embedded to said online marketplace (e.g. website or mobile app) and associated computer software and hardware; and
an out-of-band mechanism, for describing in a machine-readable way the construction of the chimera from its component data to all stages in the manufacturing workflow.
